(19) United States
(12) Patent Application Publication
(10) Pub. No.: US 2020/0165834 A1
(43) Pub. Date: May 28, 2020

(54) FLAGPOST TO FACILITATE VISIBILITY AND SAFETY OF AN OBJECT

(71) Applicant: Jeffrey Mark Parrish, Thornton, CO (US)

(72) Inventor: Jeffrey Mark Parrish, Thornton, CO (US)

(21) Appl. No.: 16/696,816

(22) Filed: Nov. 26, 2019

Related U.S. Application Data
(60) Provisional application No. 62/917,168, filed on Nov. 26, 2018.

(51) Int. Cl. E04H 12/32; G09F 17/00; E04H 12/18

(52) U.S. Cl. CPC E04H 12/32; G09F 2017/0066; E04H 12/187; G09F 17/00

(57) ABSTRACT

Disclosed herein is a flagpost to facilitate visibility and safety of an object. Accordingly, the flagpost may include a flagpole and a flag. Further, the flagpole may include a plurality of flagpole segments. Further, any two flagpole segments of the plurality of flagpole segments may be detachably coupled. Further, the flag stand may be configured to be affixed on at least one surface of an object using at least one adhesive. Further, the flag stand may be detachably coupled to the flagpole.

The current application claims a priority to the U.S. Provisional Patent application Ser. No. 62/917,168 filed on Nov. 26, 2018.

### FIELD OF THE INVENTION

The present invention relates generally to the field of equipment for safety, protection, and rescue. More specifically, the present disclosure relates to a flagpost to facilitate visibility and safety of an object.

### BACKGROUND OF THE INVENTION

Flagposts are often installed on small watercraft in order to increase their visibility in any type of weather conditions. The flagposts help in identification of the watercraft as well as keep the watercraft safe from other larger motorized speed boats. Due to the ever-increasing popularity of water sports, the lakes and waterways are becoming more congested which makes it difficult to identify smaller watercraft.

Existing techniques for a flagpost to facilitate visibility and safety of an object are deficient with regard to several aspects. For instance, current technologies do not provide a flagpost which can be easily attached to the watercraft. Moreover, current technologies require hardware and tools for installing a flagpost. Further, current technologies require holes to be drilled in the watercraft. Therefore, there is a need for an improved flagpost to facilitate visibility and safety of an object that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a flagpost to facilitate visibility and safety of an object, in accordance with some embodiments. Accordingly, the flagpost may include a flagpole and a flag. Further, the flagpole may include a plurality of flagpole segments. Further, any two flagpole segments of the plurality of flagpole segments are detachably coupled. Further, the flag stand configured to be affixed on at least one surface of an object using at least one adhesive. Further, the flag stand may be detachably coupled to the flagpole.

Further disclosed herein is a flagpost to facilitate visibility and safety of an object, in accordance with some embodiments. Accordingly, the flagpost may include a flagpole and a flag stand. Further, the flagpole may include a plurality of flagpole segments. Further, any two flagpole segments of the plurality of flagpole segments are detachably coupled. Further, the flag stand configured to be detachably affixed on at least one surface of an object using at least one adhesive. Further, the flag stand may be detachably coupled to the flagpole.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 is a front view of a flagpost, in accordance with some embodiments.

FIG. 2 is a perspective view of the flagpost in a partially-folded configuration, in accordance with some embodiments.

FIG. 3 is a perspective view of the flagpost in a folded configuration, in accordance with some embodiments.

FIG. 4 is a perspective view of a flagpost in a partially-folded configuration, in accordance with some embodiments.

FIG. 5 is a perspective view of the flagpost in a folded configuration, in accordance with some embodiments.

FIG. 6 is a perspective view of the flagpost in an erect configuration, in accordance with some embodiments.

FIG. 7 is a partial view of the flagpost in a partially-folded configuration, in accordance with some embodiments.

FIG. 8 is a partial view of the flagpost in a partially-folded configuration, in accordance with some embodiments.

FIG. 9 is a perspective view of a first connector section of the flagpost, in accordance with some embodiments.

FIG. 10 is a bottom view of the first connector section of the flagpost, in accordance with some embodiments.

FIG. 11 is a side view of the first connector section of the flagpost, in accordance with some embodiments.

FIG. 12 is a cross-sectional view of the first connector section of the flagpost along line A-A′, as shown in FIG. 10, in accordance with some embodiments.

FIG. 13 is a cross-sectional view of the first connector section of the flagpost along line B-B′, as shown in FIG. 10, in accordance with some embodiments.

FIG. 14 is a top view of a second connector section of the flagpost, in accordance with some embodiments.

FIG. 15 is a cross-sectional view of the second connector section of the flagpost along line A-A′, as shown in FIG. 14, in accordance with some embodiments.

FIG. 16 is a perspective view of the second connector section of the flagpost, in accordance with some embodiments.

FIG. 17 is a bottom view of the second connector section of the flagpost, in accordance with some embodiments.

FIG. 18 is a perspective view of the flagpost in an erect configuration, in accordance with some embodiments.

FIG. 19 is a perspective view of the flagpost in a partially-folded configuration, in accordance with some embodiments.

FIG. 20 is a perspective view of the flagpost installed on a watercraft, in accordance with some embodiments.

FIG. 21 is a front view of a flagpost, in accordance with some embodiments.

FIG. 22 is a perspective view of the flagpost in a partially-folded configuration, in accordance with some embodiments.

FIG. 23 is a perspective view of the flagpost in a folded configuration, in accordance with some embodiments.

FIG. 24 is a perspective view of a first connector section of the flagpost, in accordance with some embodiments.

FIG. 25 is a perspective view of the second connector section of the flagpost, in accordance with some embodiments.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a flagpost to facilitate visibility and safety of an object, embodiments of the present disclosure are not limited to use only in this context.

Overview:

The present disclosure describes a flagpost to facilitate visibility and safety of an object. The flagpost may be called Peel & Stick Safety Flag. The flagpost consists of two pieces;

1. The “flagstick” with an attached flag on one end and a twist-lock (female) connector on the other.

2. The “Base” locking (male) connector, which permanently affixes to the craft/object with the use of adhesive tape.

The flagpoles may be made of a hollow flexible fiberglass pole 7 mm in diameter. Poles may be offered in different lengths and broken down in 3 equal length pieces. E.g. a fully extended 6′ pole may consist of three separate pieces cut at 24″ each and attached together using an elastic “shock cord” running through the middle of each of the three 24″ poles.

There may be a metal ferrule (sleeve/collar) at the end of each pole that connects the 3 sections together creating the extended 6′ pole. Allowing the pole to be broken down when not in use for easier transportation, handling, and storage. A high visibility Safety colored flag may be affixed to the top of the pole. A twist locking (female) connector made of a polycarbonate plastic material may be affixed to the bottom of the pole for easy on and off connection to the Base.

The Base may be a flat 3.5″ diameter circle with a small protruding (male) twist-lock connector atop.

The connector may have a 7-degree angle so as when the flagpole is attached to the rear of the craft/object it may have a better appearance and natural look. The Base may also be made of a polycarbonate plastic material

To permanently affix the Base to the craft/object there may be a circular peel and stick adhesive tape attached to the bottom. The tape may consist of an extremely aggressive 3M VHB double-sided product for a permanent bond. Simply peel and stick the “Base” permanently to the vessel. Extend and lock in the “flagpole”. Unlock and breakdown flag for storage and transportation when not in use.

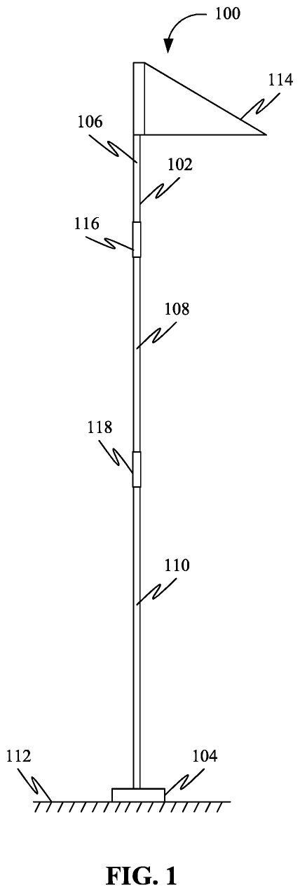

Referring now to figures, FIG. 1 is a front view of a flagpost 100, in accordance with some embodiments. Accordingly, the flagpost 100 may include a flagpole 102 and a flag stand 104. Further, the flagpole 102 may include a plurality of flagpole segments 106-110. Further, any two flagpole segments of the plurality of flagpole segments 106-110 are detachably coupled.

Further, the flag stand 104 configured to be affixed on at least one surface 112 of an object (not shown) using at least one adhesive. Further, the flag stand 104 may be detachably coupled to the flagpole 102. Further, the object may include a watercraft such as, but not limited to, a kayak, a stand-up paddleboard, a raft, a canoe, a dinghy, an inflatable boat, etc., or a land vehicle such as, but not limited to, a scooter, a rascal scooter, an electric car, a bicycle, a tricycle, etc. Further, the at least one surface 112 may include an inflatable, a solid structure, etc. Further, the at least one adhesive may include one or more of a glue, an epoxy, a plastic agent, etc. to create the required bonding between the flag stand 104 and the at least one surface 112. Further, the at least one adhesive may be designed for a one-time use. Further, the at least one adhesive may help in be permanently affixing the flag stand 104 to the at least one surface 112. Further, the at least one adhesive may be applied to a base of the flag stand 104 with a cover protecting the adhesive from exposure. Further, a user may quickly peel off the cover to expose the at least one adhesive and stick the adhesive on the at least one surface 112.

Further, in some embodiments, the flagpost 100 further may include at least one flag 114 detachably attached to an apex end (not shown) of the flagpole 102. Further, the at least one flag 114 may be configured in at least one flag configuration ensuring visibility of the at least one flag 114. Further, the at least one flag configuration may include a shape such as, but not limited to, a rectangular shape, a triangular shape, a square shape, etc.

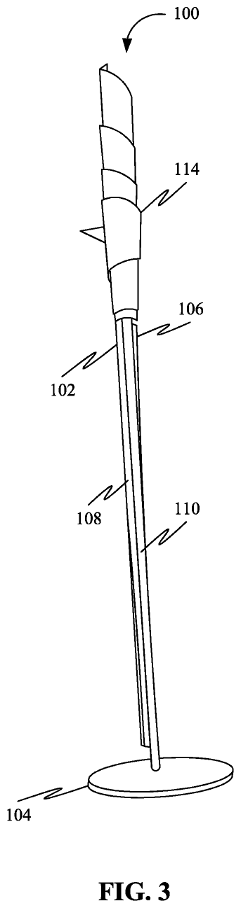

Further, in some embodiments, the plurality of flagpole segments 106-110 may be configured to arrange in at least one flagpole configuration. Further, the at least one flagpole configuration may include at least one folded configuration and an erect configuration, as shown in FIG. 3 and FIG. 1 respectively. Further, each flagpole segment of the plurality of flagpole segments 106-110 may be detached in the at least one folded configuration. Further, the each flagpole segment may be attached in the erect configuration.

Further, in some embodiments, the flagpost 100 further may include at least one adhesive panel (not shown) disposed on the flag stand 104. Further, the at least one adhesive panel may include a top surface and a bottom surface. Further, the top surface and the bottom surface are coated with the at least one adhesive. Further, the top surface may be attached to a rear surface of the flag stand 104 and the bottom surface may be attached to the at least one surface 112.

Further, in some embodiments, the plurality of flagpole segments 106-110 may include a base flagpole segment and at least one retractable flagpole segment. Further, the at least one retractable flagpole segment may be configured to transition between a plurality of flagpole positions in relation to the base flagpole segment. Further, the plurality of flagpole positions may include at least one extended position and a retracted position.

Further, in some embodiments, the flagpole 102 may include a hollow cylindrical structure and an elastic string disposed within the hollow cylindrical structure. Further, the elastic string, in an instance, may include a shock cord. Further, a first end of the elastic string may be attached to an apex end of the flagpole 102. Further, the second end of the elastic string may be attached to the base end. Further, the any two flagpole segments are detachably coupled using the elastic string.

Further, in some embodiments, each flagpole segment of the plurality of flagpole segments 106-110 may include at least one flag connector 116-118 disposed on at least one flagpole segment end. Further, the any two flagpole segments are detachably coupled in at least one flagpole arrangement using the at least one flag connector 116-118.

Further, in some embodiments, the at least one adhesive may include at least one adhesive. Further, the at least one adhesive detachably affixed the flag stand 104 to the at least one surface 112.

Further, in some embodiments, the flagpole 102 may be associated with a flagpole length. Further, the flagpole length may be 5 feet. Further, in some embodiments, the plurality of flagpole segments 106-110 may include three flagpole segments. Further, each flagpole segment of the three flagpole segments may be associated with a flagpole segment length. Further, the flagpole segment length may be 20 inches.

Further, in some embodiments, the flagpole 102 may be associated with a flagpole length. Further, the flagpole length may be 6 feet. Further, in some embodiments, the plurality of flagpole segments 106-110 may include three flagpole segments. Further, each flagpole segment of the three flagpole segments may be associated with a flagpole segment length. Further, the flagpole segment length may be 24 inches.

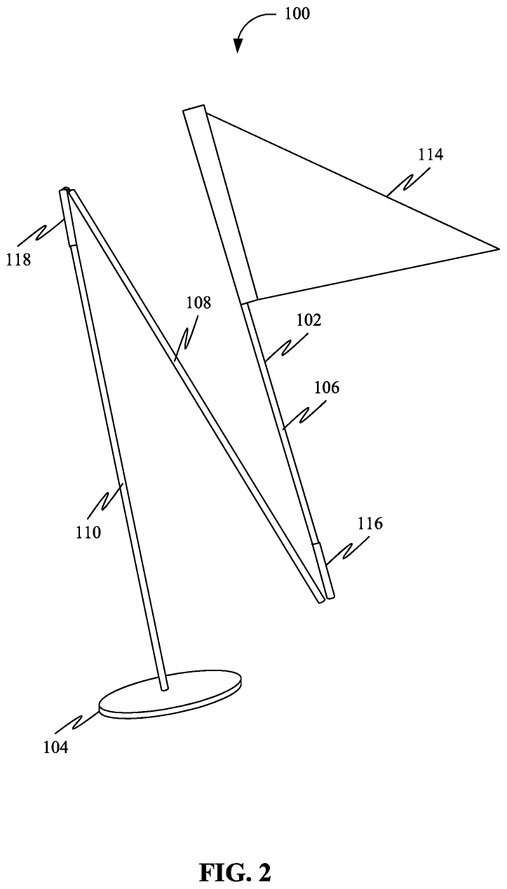

FIG. 2 is a perspective view of the flagpost 100 in a partially-folded configuration, in accordance with some embodiments.

FIG. 3 is a perspective view of the flagpost 100 in a folded configuration, in accordance with some embodiments.

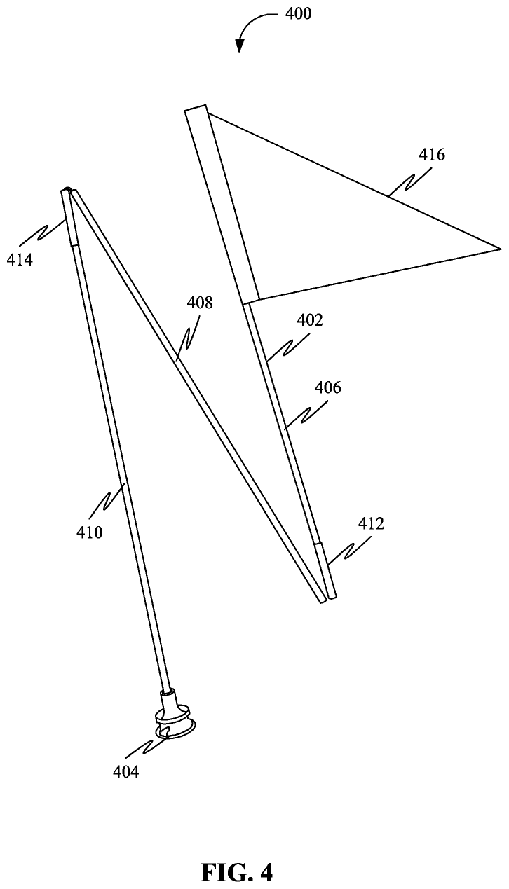

FIG. 4 is a perspective view of a flagpost 400 in a partially-folded configuration, in accordance with some embodiments. Accordingly, the flagpost 400 may include a flag pole 402. Further, the flagpole may include a plurality of flagpole segments 406-410. Further, any two flagpole segments of the plurality of flagpole segments 406-410 are detachably coupled.

Further, in some embodiments, each flagpole segment of the plurality of flagpole segments 406-410 may include at least one flag connector 412-414 disposed on at least one flagpole segment end. Further, the any two flagpole segments are detachably coupled in at least one flagpole arrangement using the at least one flag connector 412-414.

Further, in some embodiments, the flagpost 400 further may include at least one flag 416 detachably attached to an apex end (not shown) of the flagpole 402. Further, the at least one flag 416 may be configured in at least one flag configuration ensuring visibility of the at least one flag 416. Further, the at least one flag configuration may include a shape such as, but not limited to, a rectangular shape, a triangular shape, a square shape, etc.

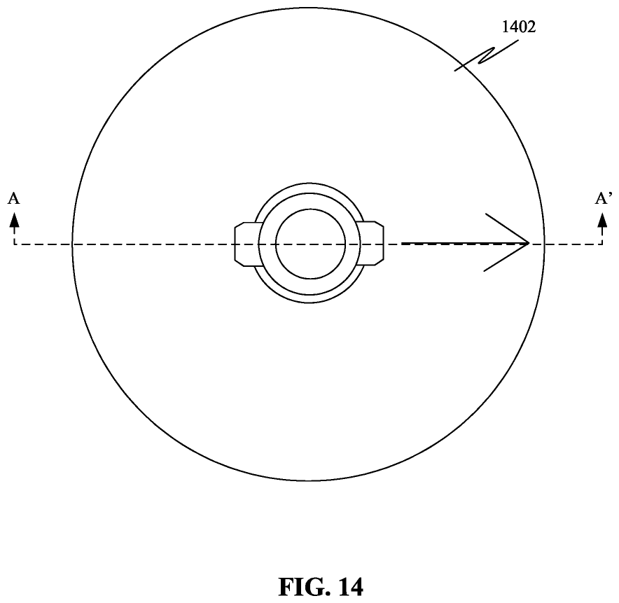

Further, in some embodiments, the flag stand (not shown) may include a first connector section 404 and a second connector section 1402, as shown in FIG. 14. Further, the flagpole 402 may be coupled to the first connector section 404. Further, the second connector section 1402 may be configured to be affixed on the at least one surface (not shown) using the at least one adhesive. Further, the first connector section 404 and the second connector section 1402 may be detachably coupled. Further, in some embodiments, the first connector section 404 may include at least one connector receptacle. Further, the second connector section 1402 may include at least one protrusion. Further, the at least one receptacle may be configured to receive the at least one protrusion. Further, in some embodiments, the first connector section 404 may be configured to be sloped in at least one inclination in relation to the second connector section 1402. Further, the flagpole 402 may be coupled to the first connector section 404 may be configured to slope in the at least one inclination.

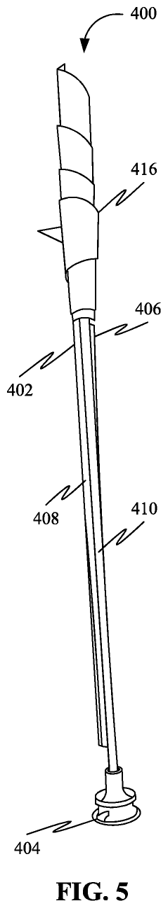

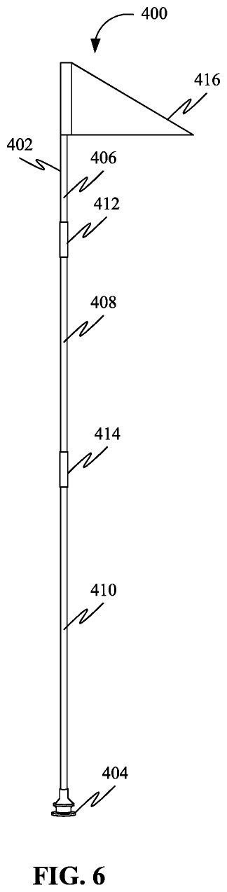

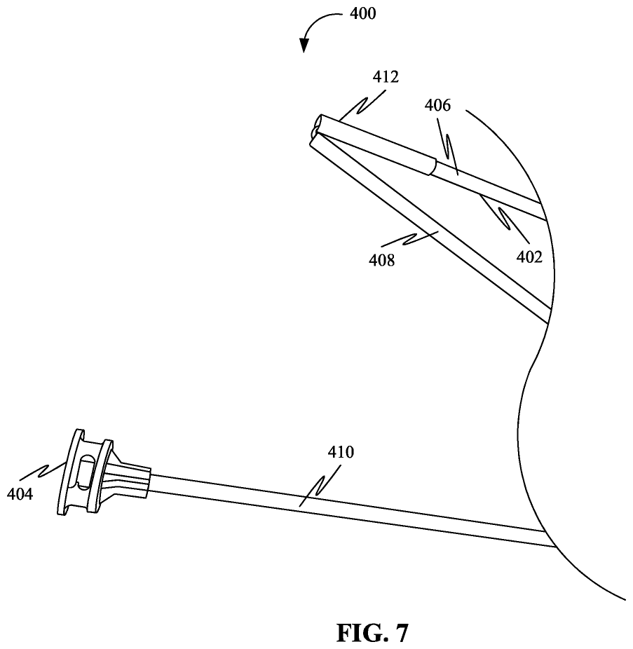

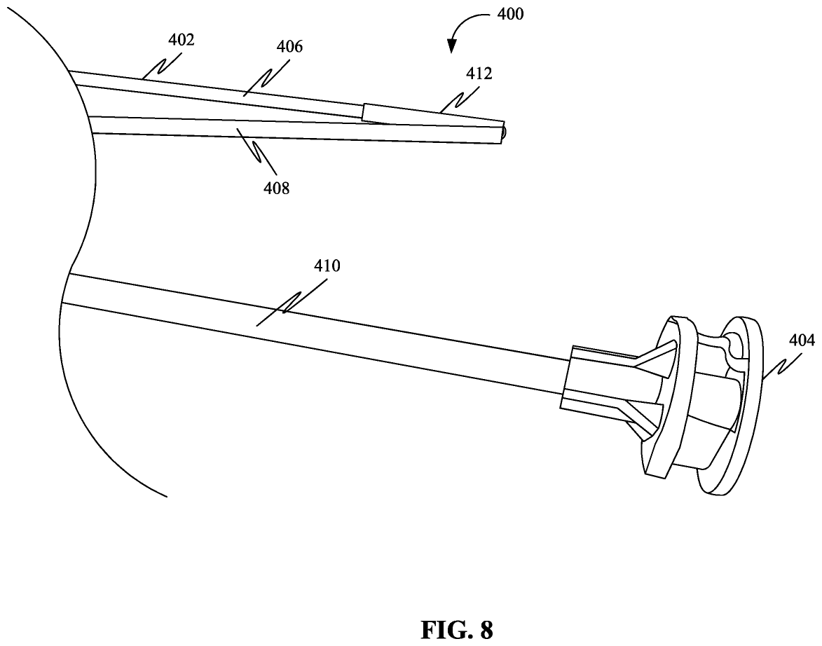

FIG. 5 is a perspective view of the flagpost 400 in a folded configuration, in accordance with some embodiments. FIG. 6 is a perspective view of the flagpost 400 in an erect configuration, in accordance with some embodiments. FIG. 7 is a partial view of the flagpost 400 in a partially-folded configuration, in accordance with some embodiments. FIG. 8 is a partial view of the flagpost 400 in a partially-folded configuration, in accordance with some embodiments.

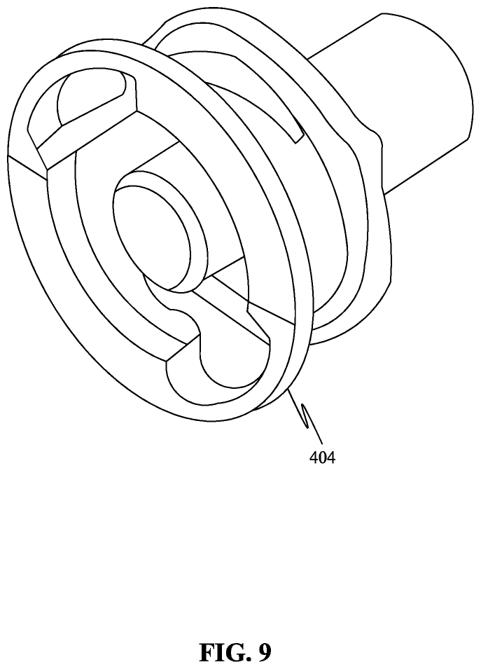

FIG. 9 is a perspective view of a first connector section 404 of the flagpost 400, in accordance with some embodiments. Further, the first connector section 404 may include a twist lock female part. Further, the twist-lock female part may be constructed from a polycarbonate plastic material.

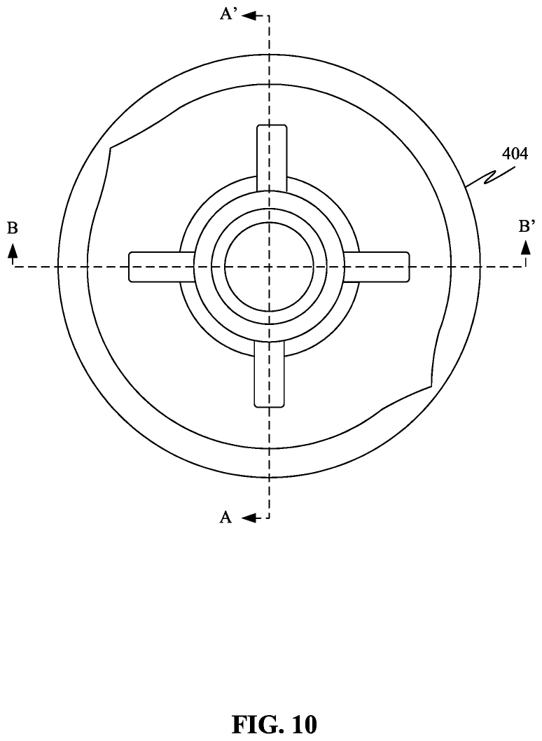

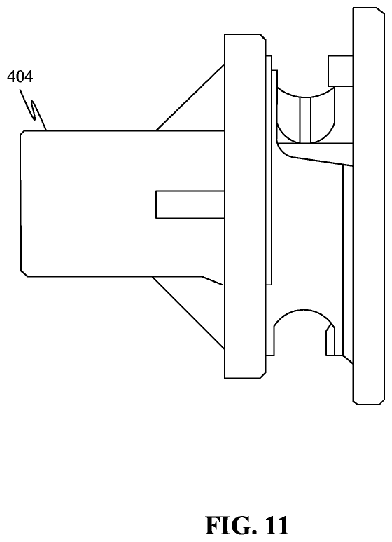

FIG. 10 is a bottom view of the first connector section 404 of the flagpost 400, in accordance with some embodiments. FIG. 11 is a side view of the first connector section 404 of the flagpost 400, in accordance with some embodiments.

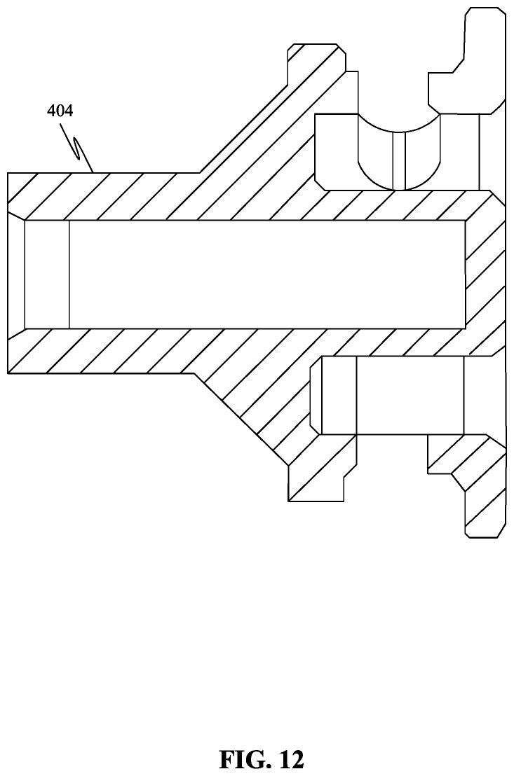

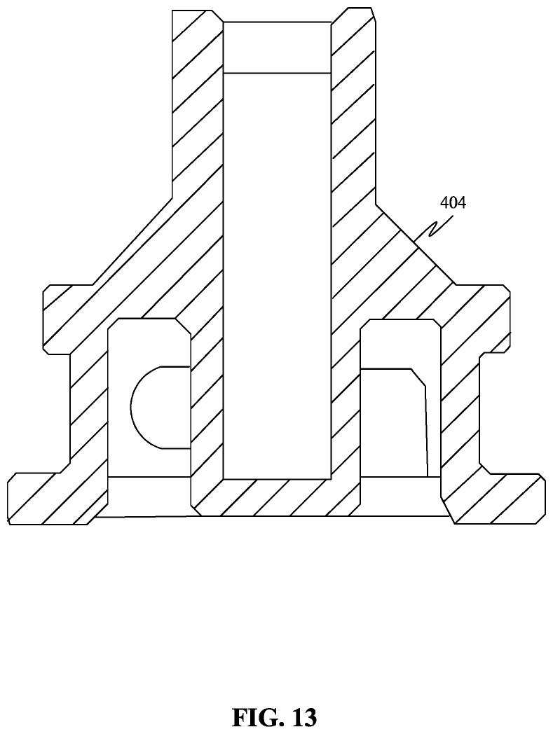

FIG. 12 is a cross-sectional view of the first connector section 404 of the flagpost 400 along line A-A′, as shown in FIG. 10, in accordance with some embodiments. FIG. 13 is a cross-sectional view of the first connector section 404 of the flagpost 400 along line B-B′, as shown in FIG. 10, in accordance with some embodiments.

FIG. 14 is a top view of a second connector section 1402 of the flagpost 400, in accordance with some embodiments. Further, the second connector section 1402 may include a flat 3.5″ diameter circle with a twist lock male part which may be permanently fixed to the at least one surface. Further, the second connector section 1402 may include a circular peel and a stick tape attached at the bottom of the second connector section 1402. Further, the stick tape may include an extremely aggressive 3M VHB double-sided tape for a permanent bond.

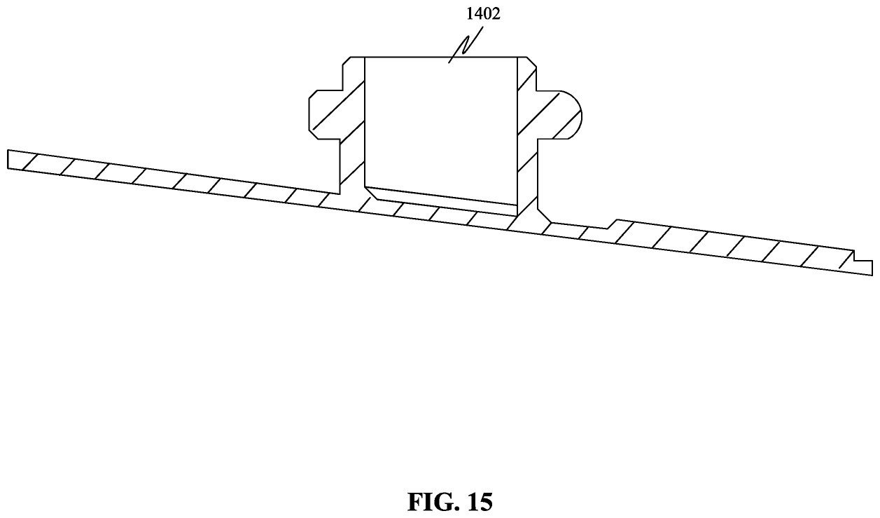

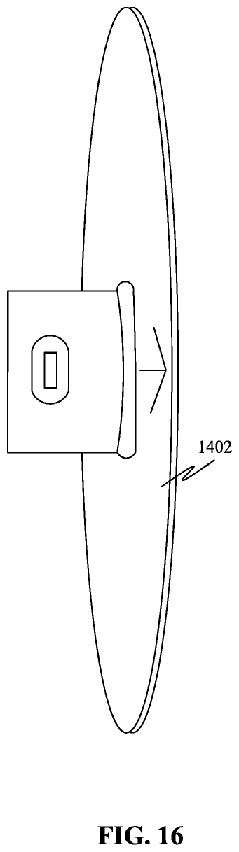

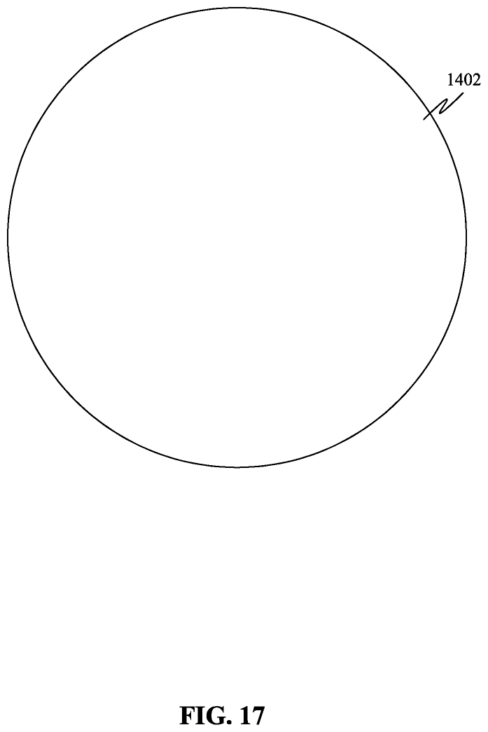

FIG. 15 is a cross-sectional view of the second connector section 1402 of the flagpost 400 along line A-A′, as shown in FIG. 14, in accordance with some embodiments. This view shows a seven-degree angle. FIG. 16 is a perspective view of the second connector section 1402 of the flagpost 400, in accordance with some embodiments. FIG. 17 is a bottom view of the second connector section 1402 of the flagpost 400, in accordance with some embodiments.

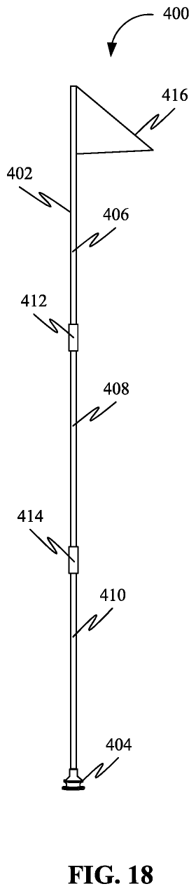

FIG. 18 is a perspective view of the flagpost 400 in an erect configuration, in accordance with some embodiments. Further, the flagpost 400 may include the 5′ pole or 60″ pole broken down into three pieces of 20″ each. Further, the 5′ pole may be associated with a hollow fiberglass of 7 mm diameter connected with the at least one flag connector 412-414 and an elastic shock cord running inside.

Further, in some embodiments, the flagpost 400 may include the 6′ pole or 72″ pole broken down into three pieces of 24″ each. Further, the 6′ pole may be associated with a hollow fiberglass of 7 mm diameter connected with the at least one flag connector 412-414 and an elastic shock cord running inside.

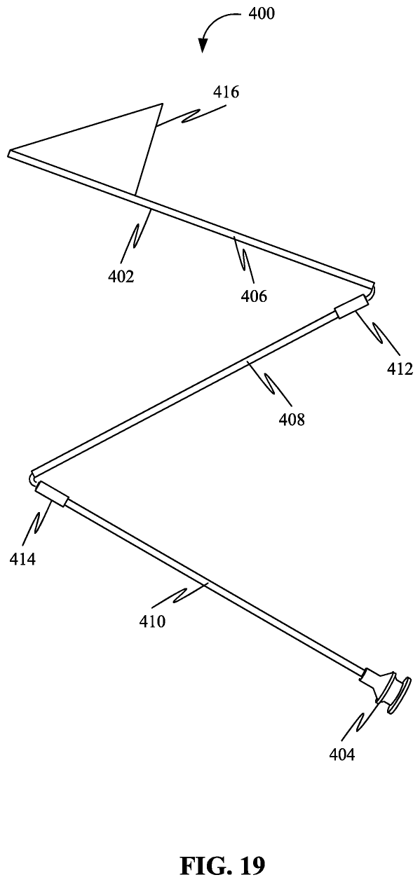

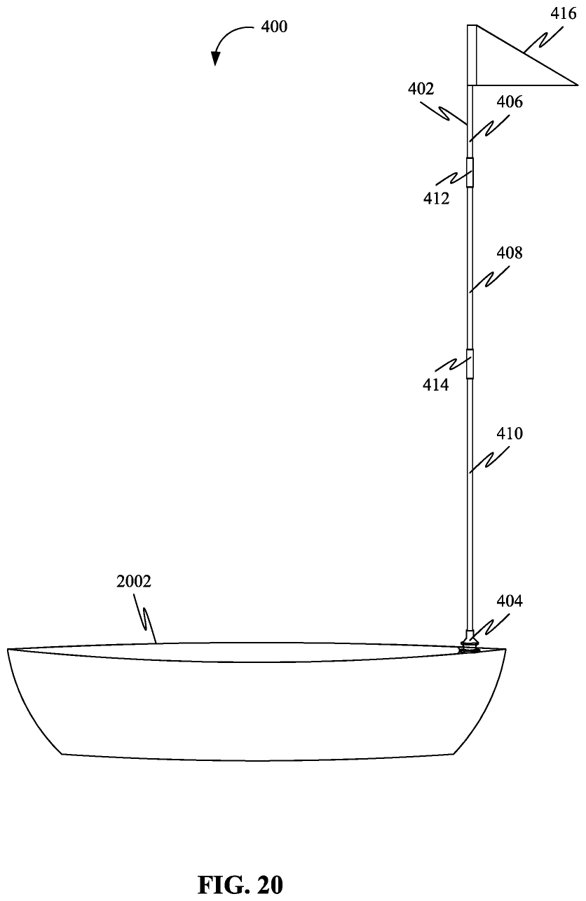

FIG. 19 is a perspective view of the flagpost 400 in a partially-folded configuration, in accordance with some embodiments. FIG. 20 is a perspective view of the flagpost 400 installed on a watercraft 2002, in accordance with some embodiments.

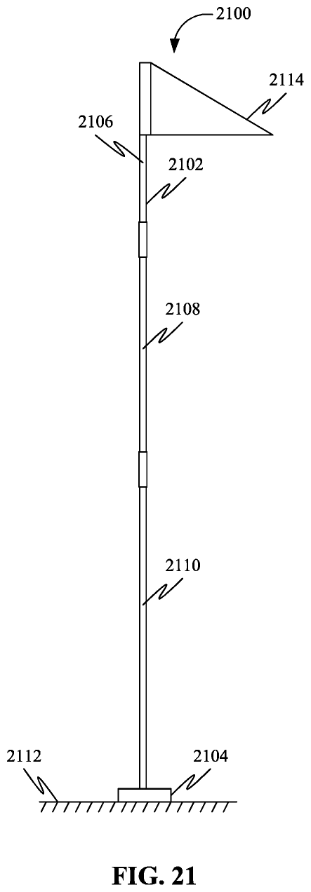

FIG. 21 is a front view of a flagpost 2100, in accordance with some embodiments. Accordingly, the flagpost 2100 may include a flagpole 2102 and a flag stand 2104. Further, the flagpole 2102 may include a plurality of flagpole segments 2106-2110. Further, any two flagpole segments of the plurality of flagpole segments 2106-2110 are detachably coupled.

Further, the flag stand 2104 configured to be detachably affixed on at least one surface 2112 of an object using at least one adhesive. Further, the flag stand 2104 may be detachably coupled to the flagpole 2102.

Further, in some embodiments, the flagpost 2100 further may include at least one flag 2114 detachably attached to an apex end of the flagpole 2102. Further, the at least one flag 2114 may be configured in at least one flag configuration ensuring visibility of the at least one flag 2114.

Further, in some embodiments, the plurality of flagpole segments 2106-2110 may be configured to arrange in at least one flagpole configuration. Further, the at least one flagpole configuration may include at least one folded configuration and an erect configuration. Further, each flagpole segment of the plurality of flagpole segments 2106-2110 may be detached in the at least one folded configuration. Further, the each flagpole segment may be attached in the erect configuration.

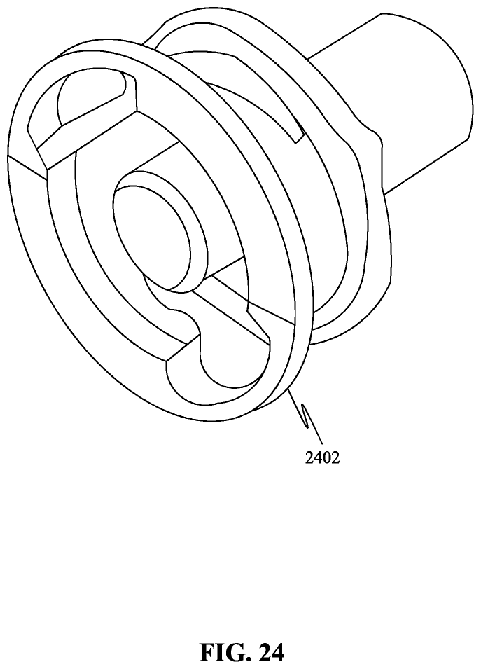

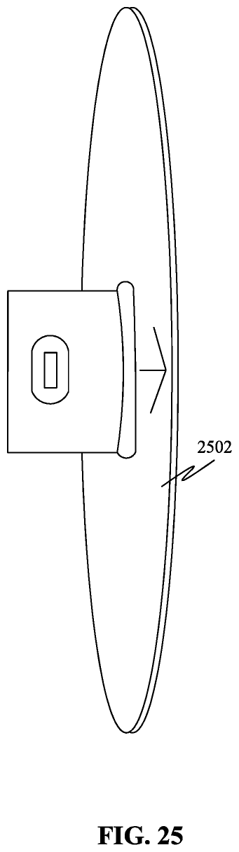

Further, in some embodiments, the flag stand 2104 may include a first connector section 2402, as shown in FIG. 24, and a second connector section 2502, as shown in FIG. 25. Further, the flagpole 2102 may be coupled to the first connector section 2402. Further, the second connector section 2502 may be configured to be affixed on the at least one surface 2112 using the at least one adhesive. Further, the first connector section 2402 and the second connector section 2502 may be detachably coupled. Further, in some embodiments, the first connector section 2402 may include at least one connector receptacle. Further, the second connector section 2502 may include at least one protrusion. Further, the at least one receptacle may be configured to receive the at least one protrusion.

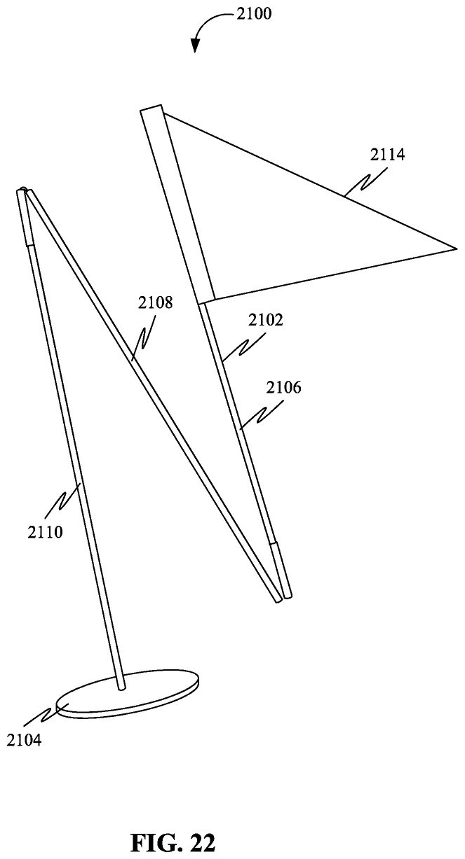

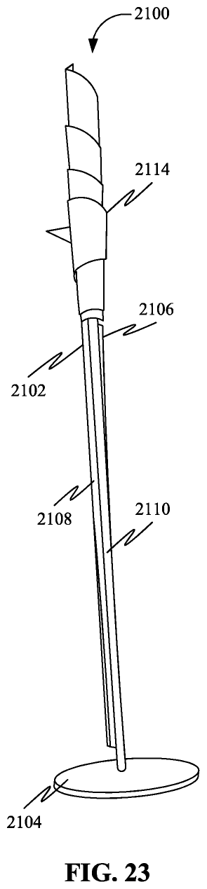

FIG. 22 is a perspective view of the flagpost 2100 in a partially-folded configuration, in accordance with some embodiments. FIG. 23 is a top view of a second connector section 2502 of the flagpost 2100, in accordance with some embodiments.

FIG. 24 is a perspective view of a first connector section of the flagpost 2100, in accordance with some embodiments. FIG. 25 is a perspective view of the second connector section of the flagpost 2100, in accordance with some embodiments.

Although the invention has been explained in relation to its preferred embodiment, it is to be understood that many other possible modifications and variations can be made without departing from the spirit and scope of the invention as hereinafter claimed.

What is claimed is:

1. A flagpost comprising:
a flagpole comprises a plurality of flagpole segments, wherein any two flagpole segments of the plurality of flagpole segments are detachably coupled; and
a flag stand configured to be affixed on at least one surface of an object using at least one adhesive, wherein the flag stand is detachably coupled to the flagpole.

2. The flagpost of claim 1 further comprising at least one flag detachably attached to an apex end of the flagpole, wherein the at least one flag is configured in at least one flag configuration ensuring visibility of the at least one flag.

3. The flagpost of claim 1, wherein the plurality of flagpole segments is configured to arrange in at least one flagpole configuration, wherein the at least one flagpole configuration comprises at least one folded configuration and an erect configuration, wherein each flagpole segment of the plurality of flagpole segments is detached in the at least one folded configuration, wherein the each flagpole segment is attached in the erect configuration.

4. The flagpost of claim 1 further comprising at least one adhesive panel disposed on the flag stand, wherein the at least one adhesive panel comprises a top surface and a bottom surface, wherein the top surface and the bottom surface are coated with the at least one adhesive, wherein the top surface is attached to a rear surface of the flag stand and the bottom surface is attached to the at least one surface.

5. The flagpost of claim 1, wherein the plurality of flagpole segments comprises a base flagpole segment and at least one retractable flagpole segment, wherein the at least one retractable flagpole segment is configured to transition between a plurality of flagpole positions in relation to the base flagpole segment, wherein the plurality of flagpole positions comprises at least one extended position and a retracted position.

6. The flagpost of claim 1, wherein the flagpole comprises a hollow cylindrical structure and an elastic string disposed within the hollow cylindrical structure, wherein a first end of the elastic string is attached to an apex end of the flagpole, wherein the second end of the elastic string is attached to the base end, wherein the any two flagpole segments are detachably coupled using the elastic string.

7. The flagpost of claim 1, wherein each flagpole segment of the plurality of flagpole segments comprises at least one flag connector disposed on at least one flagpole segment end, wherein the any two flagpole segments are detachably coupled in at least one flagpole arrangement using the at least one flag connector.

8. The flagpost of claim 1, wherein the flag stand comprises a first connector section and a second connector section, wherein the flagpole is coupled to the first connector section, wherein the second connector section is configured to be affixed on the at least one surface using the at least one adhesive, wherein the first connector section and the second connector section is detachably coupled.

9. The flagpost of claim 8, wherein the first connector section comprises at least one connector receptacle, wherein the second connector section comprises at least one protrusion, wherein the at least one receptacle is configured to receive the at least one protrusion.

10. The flagpost of claim 8, wherein the first connector section is configured to be sloped in at least one inclination in relation to the second connector section, wherein the flagpole is coupled to the first connector section is configured to slope in the at least one inclination.

11. The flagpost of claim 1, wherein the at least one adhesive comprises at least one adhesive, wherein the at least one adhesive detachably affixed the flag stand to the at least one surface.

12. The flagpost of claim 1, wherein the flagpole is associated with a flagpole length, wherein the flagpole length is 5 feet.

13. The flagpost of claim 12, wherein the plurality of flagpole segments comprises three flagpole segments, wherein each flagpole segment of the three flagpole segments is associated with a flagpole segment length, wherein the flagpole segment length is 20 inches.

14. The flagpost of claim 1, wherein the flagpole is associated with a flagpole length, wherein the flagpole length is 6 feet.

15. The flagpost of claim 14, wherein the plurality of flagpole segments comprises three flagpole segments, wherein each flagpole segment of the three flagpole segments is associated with a flagpole segment length, wherein the flagpole segment length is 24 inches.

16. A flagpost comprising:
a flagpole comprises a plurality of flagpole segments, wherein any two flagpole segments of the plurality of flagpole segments are detachably coupled; and
a flag stand configured to be detachably affixed on at least one surface of an object using at least one adhesive, wherein the flag stand is detachably coupled to the flagpole.

17. The flagpost of claim 16 further comprising at least one flag detachably attached to an apex end of the flagpole, wherein the at least one flag is configured in at least one flag configuration ensuring visibility of the at least one flag.

18. The flagpost of claim 16, wherein the plurality of flagpole segments is configured to arrange in at least one flagpole configuration, wherein the at least one flagpole configuration comprises at least one folded configuration and an erect configuration, wherein each flagpole segment of the plurality of flagpole segments is detached in the at least one folded configuration, wherein the each flagpole segment is attached in the erect configuration.

19. The flagpost of claim 16, wherein the flag stand comprises a first connector section and a second connector section, wherein the flagpole is coupled to the first connector section, wherein the second connector section is configured to be affixed on the at least one surface using the at least one adhesive, wherein the first connector section and the second connector section is detachably coupled.

20. The flagpost of claim 19, wherein the first connector section comprises at least one connector receptacle, wherein the second connector section comprises at least one protrusion, wherein the at least one receptacle is configured to receive the at least one protrusion.
